(19) United States
(12) Patent Application Publication
(10) Pub. No.: US 2002/0173993 A1
(43) Pub. Date: Nov. 21, 2002

(54) Drug advice expert

(75) Inventors: Halldor Skulason, Reykjavik (IS); Hjortur Sturluson, Reykjavik (IS); Ivar Sigurjon Helgason, Kopavogur (IS); Julius Helgi Schopka, Reykjavik (IS)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: deCODE genetics ehf. corporation

(21) Appl. No.: 10/138,097

(22) Filed: May 2, 2002

Related U.S. Application Data
(60) Provisional application No. 60/290,078, filed on May 10, 2001.

(51) Int. Cl. G06F 17/60

(52) U.S. Cl. 705/3

(57) ABSTRACT

A user-interactive computer program provides drug advice. Drugs are grouped according to their clinical and chemical characteristics in a supporting data base. For each drug, a drug database contains detailed information on pharmacokinetics, pharmaco-dynamics and drug-specific details. In response to user interaction with areas displayed on the screen, the computer program obtains pertinent drug interaction information from the database. With the obtained information, the computer program supports display of graphical screen views. Contents of the screen views include symbols for indicating respective drugs, geometrically distinguishing lines for indicating interaction between drugs, and text descriptions of drug information. Further included in the screen views are respective symbols for indicating drug warnings for pregnant or lactating women and sportspersons. Color coding may also be employed in the screen views to indicate degree of effect or warning.

### RELATED APPLICATION

This application claims the benefit of U.S. Provisional Application No. 60/290,078, filed on May 10, 2001. The entire teachings of the above application are incorporated herein by reference.

### BACKGROUND OF THE INVENTION

Currently, there exist various manuals and indexes for specifying drug interaction information. The name of a specific drug (its generic name) or active ingredient is typically used as a reference key to access the pertinent information. The information may include side effects of the drug, possible effects on pregnant or lactating women and known interactions with other drugs. Different sources provide different type and degree of information regarding such drug interaction. Thus, a prescribing physician may have to consult multiple sources to obtain the information he needs.

The physician has no automated means for considering the obtained information in a patient-specific context. There is no fundamental system that, in response to one's entering two or more drugs, provides a graphical summary or overview of interactions between the drugs selected. At least two major companies sell web access to their text based drug information: Micromedex and First Databank. First Databank also provides text-based database solutions for implementation in third-party software.

There are endless websites in Europe and the US that have text-based information on drug-drug interactions on their websites. The information is typically single drug-based and can only be read for one drug at a time. Most if not all major pharmaceutical companies have interaction information regarding their drugs on various commercial websites.

Glossary

Drug-drug Interaction

When one drug affects the pharmacological response of a second drug given at the same time. Drug interactions may be due to pharmacodynamic or pharmacokinetic effects. Consequences of drug interactions are: increased drug effects; decreased drug effects; desired consequences; adverse or undesired effects.

Drug Warning

Information concerning safety, regulations, recommendations and other information regarding the use of the drug in general or when specific patient parameters are taken into account.

Pharmacodynamic

The action or effects of drugs on living organisms.

Pharmacokinetic

The process by which a drug is absorbed, distributed, metabolized and eliminated by the body.

### SUMMARY OF THE INVENTION

An embodiment of the present invention, called the Drug Advice expert (DAX), is a software system designed for healthcare professionals. DAX's main objective is to increase the safety and speed of drug prescriptions and administration. DAX provides healthcare professionals with needed drug-related information in a format that can be easily understood at the point of care.

DAX is the only software system of its kind that delivers information to the healthcare professional in graphical format and enables the user to evaluate a great amount of complex information in a short time.

DAX is intended to be integrated into other software systems, and in at least one embodiment, is not a stand-alone application. Users of systems into which DAX has been integrated will not notice that DAX is a separate system because DAX runs as a part of the system that they are using, using only a small area of a subject application window.

DAX can be integrated into many different systems at the same workplace, allowing users to see the DAX interface in many different systems.

The design of DAX is such that all of the needed data is automatically obtained from the systems into which DAX is integrated, so that the user is not required to enter information directly into DAX. The design of DAX facilitates easy learning. Users only have to learn how to use DAX once and are then able to use DAX in any system into which it is integrated.

The present invention provides such automated means for applying drug interaction information to a patient, e.g., it considers other medications the patient is on, the additive effects, etc.

DAX is a drug expert system suite. DAX is designed for seamless integration into any computer-based drug prescription and handling system. Aimed at health care professionals, the program facilitates the task of prescribing and administrating drugs. DAX makes use of a unique knowledge base that combines drug data and advanced logic, creating a tool to assure the quality of drug prescriptions and use. Drugs are grouped according to their clinical and chemical characteristics. The drug database contains detailed information on pharmacokinetics, pharmaco-dynamics and various other drug-specific details.

Rather than merely providing access to its knowledgebase, DAX uses the data to make logical suggestions as to the next step to be taken based on various patient parameters, such as age, gender, current drug list, diagnosis, symptoms, cost, allergies and many more. In this way DAX always attempts to be one step ahead of its user in order to speed up work and increase safety. However, the user is always free to choose other solutions than those suggested by DAX.

DAX was created on the basis of a modular design. Modules may be provided separately and users can adapt the system to their own needs by combining a number of different modules. Each module may be used on its own or in interaction with other modules for maximum functionality. As the user's needs change or expand, new modules may be added. Although the modules may be used separately, a combination of modules, or even the whole suite, may be needed in order to take full advantage of the system's functionality. The same user-friendly graphical interface is used for all modules.

Accordingly, a drug advice expert represents drugs as nodes in a graph in computer a display window, and graphically represents a property associated with a first represented drug.

For example, interaction between the first drug and a second represented drug may be graphically represented with a line connecting nodes representing interacting drugs. The connecting line may further indicate whether a drug increases/decreases effectiveness of another drug, for example, by using plus signs (“+”) to indicate increased effectiveness, and minus signs (“−”) to indicate decreased effectiveness. The strength of an interaction may also be indicated, for example, by the thickness or the color of the line.

Such graphical representations of interactions can be used to show extended effects and additive effects of a drug, as well as chain reactions.

The represented drugs may be provided in a drug list, for example, a list of drugs which are prescribed to a patient. In one embodiment, interactions between some or all of the drugs on the drug list may be illustrated. In another embodiment, a new or proposed drug is represented as a node, and only interactions between the proposed drug and some or all of the drugs on the drug list may be shown.

The drug interaction representation may be responsive to patient data, including historical and/or current patient drug dosage and other data. Such data may be maintained in a database which may or may not be the same as the drug information database.

In addition to drug-drug interaction information, the displayed property may be a warning associated with the drug. Such a warning may include any or all of, and is not limited to, the following: allergic reactions, pregnancy, lactation, QT-interval prolongation, impaired ability to operate a motor vehicle/machinery, drug dependence, competitive sports, photosensitivity, general warnings, side effects, overdose, affect on at least one organ, and food/drug interactions, etc. The ability to operate a motor vehicle/machinery includes, but is not limited to, effects due to any of blurred vision, muscle relaxation, drowsiness and/or dizziness.

Possible allergic reactions of a drug may be indicated by blinking the associated node. Severity of the warning, e.g., possible cross-allergies, may be indicated using color coding.

Focus buttons, or “soft switches” may be provided on the display. Using these focus buttons, a user can selectively enable/disable different warning types.

A small window mode provides limited information but takes up only a small amount of space on the display. Alternatively, a large window mode may provide more detailed information. In one embodiment, the driver displays the large window when the user performs some action, such as clicking or double-clicking in the small window.

In one embodiment of the present invention, the software that accesses the drug information, interacts with the user and graphically displays the drug information may be integrated with an independently-developed application such as a third-party drug prescription application. The small or large window may then be integrated with that application's graphical output.

Such integration may be implemented through an application program interface (API) supplied as part of the present invention. The independently-developed application may then provide information about a patient to the present invention software via the API.

One embodiment of the present invention includes a graphical help function.

The drug information database may include, but is not limited to, any or all of pharmacokinetic, pharmacodynamic and drug-specific information. The database may be indexed according to medical standard classifications.

Furthermore, additional information may be displayed when a cursor is made to hover over a hot spot, such as a drug node, drug label, interaction line or warning. This additional information may include details and references regarding the drug, as well as one or more links to further related information.

The representation of drug warnings or other properties may additionally be based on patient characteristics, such as, but not limited to age, gender, current drug list, diagnosis, symptoms, cost and allergies.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram illustrating a preferred embodiment of the invention, in which invention software is executed on a computer or digital processing system.

FIG. 2 is a block diagram illustrating various modules that may comprise the DAX embodiment of the invention.

FIG. 3 is a high-level flowchart illustrating the basic flow of DAX.

FIG. 4 illustrates the large DAX display, corresponding with large window of FIG. 1.

FIG. 5 illustrates the focus panel when only some of the buttons are turned on.

FIG. 6 is an illustration of a screen view display of a text box in response to operation of a user-interactive spot in the large window of FIG. 4.

FIGS. 7A and 7B are schematic illustrations of symbolic cursors employed in the large window of FIG. 4.

FIG. 8 illustrates the small display mode, corresponding to the small display window 6 of FIG. 1.

FIG. 9 is an illustration of a display indicating extended effects.

FIG. 10 is an illustration of a display indicating additive effects.

FIG. 11 illustrates a simple magnifying chain reaction where fluvoxamine increases the effects of quinidine, which in turn increases the effects of digoxin.

FIGS. 12A-12D are screen views employed by a preferred embodiment of the invention software.

### DETAILED DESCRIPTION OF THE INVENTION

An embodiment of the present invention, also called DAX for “Drug Advice Expert”, is designed to be seamlessly integrated into any drug prescription and drug handling system available.

DAX is used in two main modes, namely a small window mode and a large window mode. The small window mode is designed to be visible at all times when the user is working with drugs. The small window mode is a low-detail mode that displays only dots/symbols representing the drugs/substances, connecting lines between the dots that represent interactions, and the most serious warning icon of every type that applies.

The large window mode, in which the window may consume up to the entire screen, is presented when the user clicks on the small window, or by other means of selection that are within the purview of one skilled in the art.

The screen views generated by the present invention are operable whether being viewed in a resized mode or not. As the screen is resized, the level of detail changes.

The patient's current drug list may be stored along with other patient data in a patient's history module (not shown). This historical/current patient data may be provided as input to the software 12 discussed below.

When DAX is accessed during a review of the patient's current drug list, the information on the screen is based on all drugs on the patient's current drug list. All interactions are drawn and all warnings are shown.

When DAX is accessed during the prescribing of a new drug, interactions (if they exist) between the new drug and the patient's current drug list are drawn. Warnings that apply to the new drug are shown.

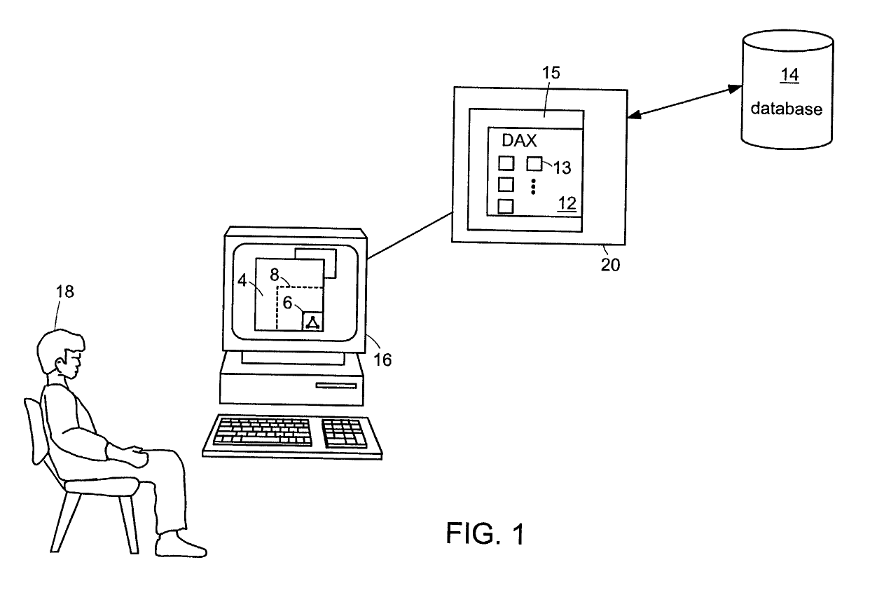

FIG. 1 is a schematic diagram illustrating a preferred embodiment of the invention, in which invention software 12 is executed on a computer 20 or digital processing system. A supporting database 14 is coupled to the computer 20 and may be located either externally or internally to the computer 20. Various I/O accessories 16, e.g., display monitor, input devices, etc., are also coupled for communication with the computer 20.

It is understood that computer 20 may be implemented as a distributed processing system or parallel digital processors and the like. In such cases, appropriate communication lines and links are used among the various digital processors and between digital processors and database 14.

In one embodiment, the DAX software 12 is integrated with one or more applications 15 supplied, for example, by a third party. While the main application 15 may control one or more windows, such as window 4, DAX 12, through its own display/interface driver (not shown) presents its information in a subwindow 6, 8. This subwindow is normally a small window 6, but may be larger as indicated by dashed lines 8 when large window mode is active. The two window modes (small and large) are discussed in more detail below.

In any system architectural design in which the invention may be deployed, the invention software 12 is responsive to input from an end user 18 through I/O means 16 (e.g., keyboard, mouse, etc.) and/or other connecting modules (e.g., patient data module, patient history module, etc.), which may be part of the main application 15. Such a connecting drug handling system into which the invention software is integrated, allows the end user 18 to browse through a drug selection list or a patient's current medications/drug list.

The DAX software 12 itself maybe broken down into several modules 13, some of which need not be installed in every implementation.

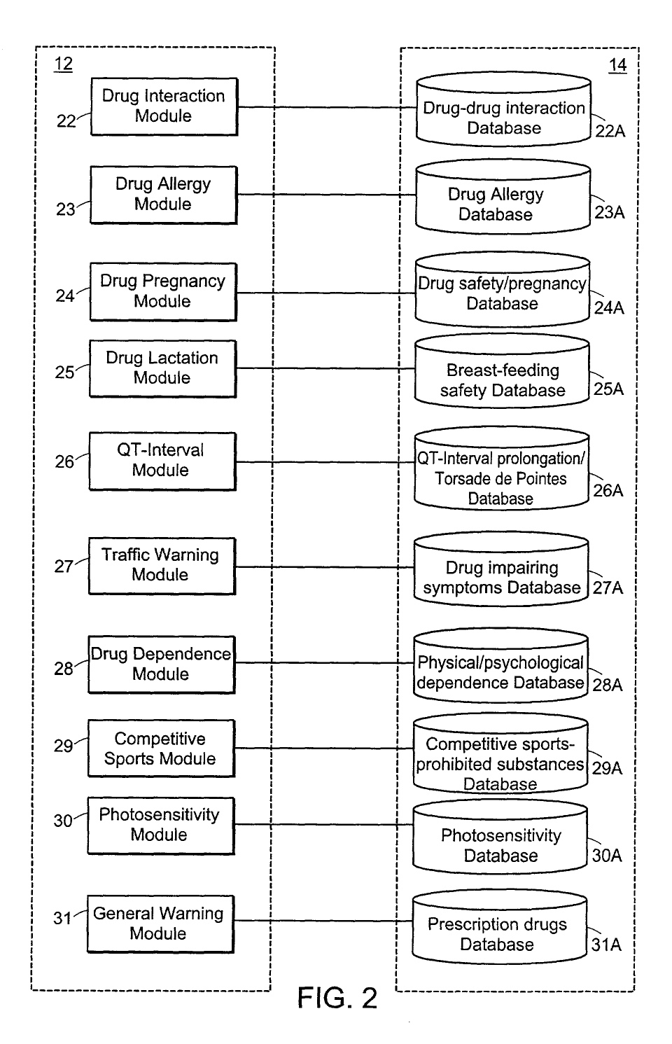

FIG. 2 is a block diagram illustrating various modules that may comprise DAX 12.

A drug interactions module 22 may contain a large database 22A of up-to-date drug-drug interaction information. The module 22 uses a unique graphical approach to display complex drug-drug interaction chains in polypharmacy in an easily viewed format. The screen indicates interactions between and effects on the interacting drugs.

A drug allergy module 23 may contain a database 23A of up-to-date drug allergy information. This module 23 may identify and warn the user of possible allergic reactions caused by different brand names and may also identify drugs with similar chemical structure when there is a risk of allergic cross-reactivity.

A drug pregnancy module 24 may contain a database 24A of up-to-date information regarding the safety of drugs during pregnancy.

A drug lactation module 25 may contain a database 25A of up-to-date information regarding the safety of drugs during breast-feeding.

A QT-interval prolongation module 26 may contain a database 26A of up-to-date information regarding drugs that cause QT-interval prolongation and/or Torsade de Pointes.

A traffic warning module 27 may contain a database 27A of up-to-date information regarding drugs that may cause blurred vision, muscle relaxation, drowsiness, dizziness, or other symptoms that impair the user's ability to drive a motor vehicle or operate machinery.

A drug dependence module 28 may contain a database 28A of up-to-date information regarding drugs that can cause physical and/or psychological dependence.

A competitive sports module 29 may contain a database 29A with information regarding substances prohibited by the International Olympic Committee (IOC) or other sports associations.

A photosensitivity module 30 may contain a database 30A of up-to-date information regarding photosensitivity caused by drugs.

A general warning module 31 may contain a database 31A of up-to-date information with respect to new issues concerning prescription drugs. For example, this module may contain information from drug authorities such as the U.S. Food and Drug Administration (FDA) or the European Agency for Evaluation of Medicinal Products (EMEA), as well as information from drug manufacturers and more.

The above-described databases 22A-31A are shown collectively as 14 in FIG. 1.

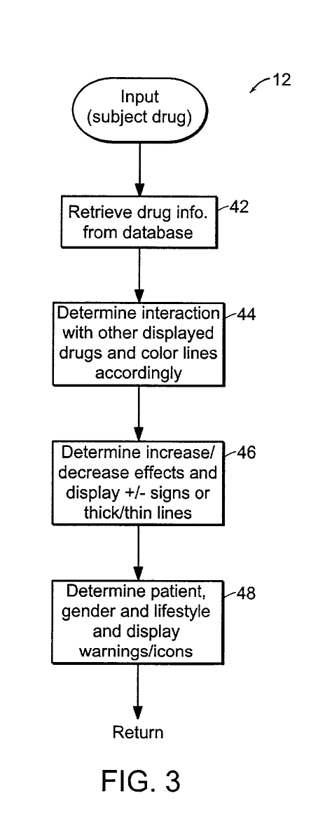

FIG. 3 is a high-level flowchart illustrating the basic flow of DAX.

Given one or more subject drugs, the invention software 12 retrieves, from database 14, information regarding each drug (step 42). Based on that information, the invention software 12 prepares and presents for display: (i) colored lines indicating interactions between drugs currently displayed on the screen (step 44); (ii)+ signs or thicker lines for increased effects, and − signs or thinner lines for decreased effects (step 46); and (iii) warning icons or symbols concerning use of the drug, for example, by a pregnant or lactating woman, or a competitive sports person (step 48).

Other indications prepared and displayed by the invention software 12 may include (a) chain reactions (additive effects, cross over effects or balance out) between two drugs displayed in the current screen view, (b) side effects, (c) food and drug interaction, (d) environmental interaction (sensitivity to sun, light, etc.), (e) effects on organs such as the liver or kidney, (f) overdose information and the like.

In the preferred embodiment, database 14 indexes or organizes drugs according to medical standard classifications (e.g., U.S. National Formulary, World Health Organization Pharmacopeia), and thus references specific drug and drug class interactions in each drug entry.

The database 14 may contain pharmacokinetics, pharmacodynamic and drugspecific information for various drugs.

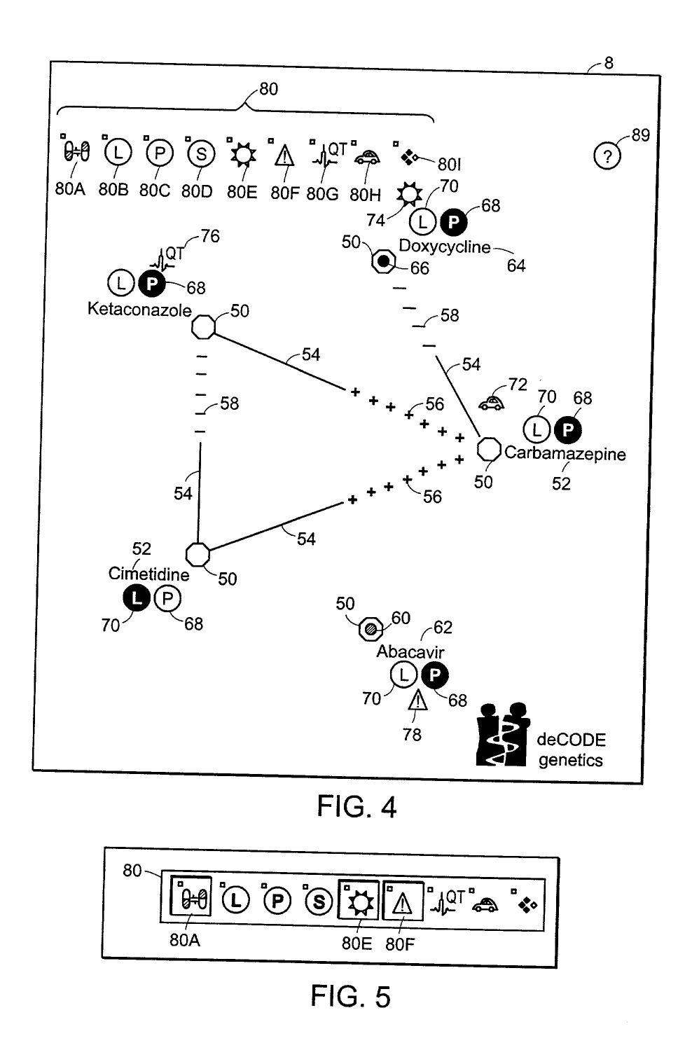

FIG. 4 illustrates the large DAX display 8, corresponding with the large window 8 of FIG. 1. In this embodiment, each drug is represented graphically as a node 50 comprising a large white circle with a black outline. It would be recognized by one skilled in the art that symbols or shapes other than circles could also be used for the drug nodes 50.

Next to each node 50 is a label 52 containing either the brand name or a generic name of the drug being representd by the node 50.

Each drug-drug interaction is represented as a line 54 connecting nodes 50 of drugs involved in the interaction. Plus signs (+) 56 on a connecting line 54 indicate increased effects of the drug that the pluses (+) stand closest to. Minus signs (−) 58 on a connecting line 54 indicate decreased effects of the drug that the minuses (−) stand closest to. In the example illustrated in FIG. 4, Cimetidine and Ketoconazole each cause Carbamazepine to have an increased effect, while Cimetidine causes Ketoconazole to have a decreased effect.

Alternatively, the effects of the drug-drug interaction on the potency or effect of the interacting drugs may be indicated by a thicker line for increased effects and a thinner line for decreased effects.

The number of +/− signs and/or degree of line width variation can be used to indicate the magnitude of potency or effect changes.

The connecting lines 54 may also be colored to indicate the type and/or severity of the interactions. For example, in one embodiment, a red line indicates severe clinical consequences/contraindications. A yellow line indicates doses have to be reconsidered and/or plasma levels monitored. A green line indicates clinical significance is questionable. A blue line indicates clinical significance is unlikely. A gray line indicates that the two drugs on each end of the line contain the same or similar active ingredient.

Other colors are suitable and in the purview of one skilled in the art. The type of line drawn between nodes 50 can also be used to further indicate the type of interaction. For example, dotted lines, double lines, triple lines, dot dash lines and the like may be used to indicate the above or other aspects of interactions.

A solid line indicates that the effects are unchanged or unknown. That is, solid lines indicate that the interaction does not change the dose-related effects of the drugs, but may cause some other events.

For example, the kidneys have two ways to filter potassium from the blood. Two drug classes, ACE-inhibitors and spironolacton, each block one of these routes. If used together, they result in elevated potassium levels, a life-threatening condition caused by this “interaction”. The effects of the drugs, however, are unchanged since the drugs do not interfere with each other.

Drug allergies are indicated with a red drug label 62 and a red blinking dot 60, as illustrated by Abacavir in FIG. 4. Possible cross-allergies are indicated with a orange drug label 64 and a orange blinking dot 66, as with Doxycycline in FIG. 4. Other colors are suitable.

Icons 68, 70, 76, 78, 72 and 74 drawn near a drug label 52, 62 indicate various warnings that apply to the corresponding drug. The icons are picture or letter symbols that are descriptive for each warning. The color of the icon or the background of the icon may signify the severity of the warnings. In one embodiment, green, yellow and red are used to indicate increasing levels of seriousness. Other colors may be used.

Pregnancy warnings 68 are indicated with the letter “P” contained in a colored circle. The circle is colored red to indicate that the drug should not be used during pregnancy and that in some occasions, contraception is necessary when this drug is prescribed to a fertile woman. In some instances, this warning may also apply to males.

A yellow pregnancy icon indicates that clinical experience from use during pregnancy is limited. A green pregnancy icon indicates that the drug is considered compatible with pregnancy.

Lactation warnings 70 are indicated with the letter “L” contained in a colored circle. The circle is colored red to indicate that the drug should not be used during breast-feeding. A yellow lactation icon indicates that the risk to the baby cannot be estimated from existing data. A green lactation icon indicates that the corresponding drug is thought to be compatible with breast-feeding.

Drugs which impede a patient's ability to operate a motor vehicle or other machinery are indicated with a small red car symbol 72. Photosensitivity warnings are indicated with a yellow sun 74. QT-interval prolongation warnings 76 are indicated with a small red EKG symbol (80G).

Similarly, competitive sports warnings are indicated with the letter S on a red or yellow filled circle (80D). The icon is colored red to indicate that the drug is prohibited in and out of competition. The icon is colored yellow to indicate that the drug is prohibited just in competition.

Physical and/or psychological drug dependence warnings are indicated with three black and one red diamonds (80I). General warnings 78, such as warnings from drug authorities (FDA, EMEA) and drug manufacturers, are foregoing with a red and yellow triangle with a black exclamation mark.

In the example of FIG. 4, Ketoconazole has certain concerns involving pregnant and/or lactating patients as well as heart patients, as indicated by the displayed pregnancy warning symbol 68, lactation warning 70 and QT-interval prolongation warning 76, respectively.

Similarly, Carbamazepine has concerns for pregnant and/or lactating patients as indicated by the pregnancy warning 68 and lactation warning 70, as well as effects on driving or the ability to operate machinery. The latter is indicated by car symbol 72 in FIG. 4.

One skilled in the art would recognize that the icons could comprise different pictures, symbols or letters than those described above.

A row of focus buttons or “soft switches” 80 is located in the left upper corner of the large window 8. These buttons may be used to select which types of warnings should be displayed. Each type of warning that can be disabled is represented by an icon: 80A—drug interaction; 80B—lactation; 80C—pregnancy; 80D—competitive sports; 80E—photosensitivity; 80F—general warnings; 80G—QT-interval prolongation; 80H—operator warnings; and 80I—drug dependency.

By default, all information is displayed and all buttons are grayed out, as shown in FIG. 4. When the mouse pointer is moved over or hovers over a focus button 80, a gray box appears around the button. After a short delay, text may be displayed that explains the buttons function. Each focus button 80 can be turned on (associated warning type enabled) or off (associated warning type disabled) by pressing a mouse button while the focus button 80 is outlined. When a focus button 80 is turned on, it changes from an “off” state to an “on” state (i.e., not grayed out), and the information displayed in the window 8 is changed accordingly.

It is possible to have many focus buttons 80 turned on at the same time. For security reasons, drug allergy warnings cannot be turned off. When all focus buttons 80 are either turned on or off, DAX reverts into default mode and shows all information.

The help indicator/button 89 is discussed later.

FIG. 5 illustrates the focus panel 80 when only some of the buttons are turned on. Here, only buttons 80A, 80E and 80F are on, indicating that only information pertaining to drug-drug interactions, photosensitivity and general warnings will be displayed. No other warnings (except allergies) will be displayed.

All items displayed in large window mode may be interactive. If the pointer is moved over a line, node, label, icon or other interactive spot on the screen, the subject spot visually changes to indicate that it is being focused on. The visual changes can include a change in color or the appearance of a dotted line around the spot. Further, a text window opens that contains a detailed description on the interactions, warnings or help associated with the interactive spot.

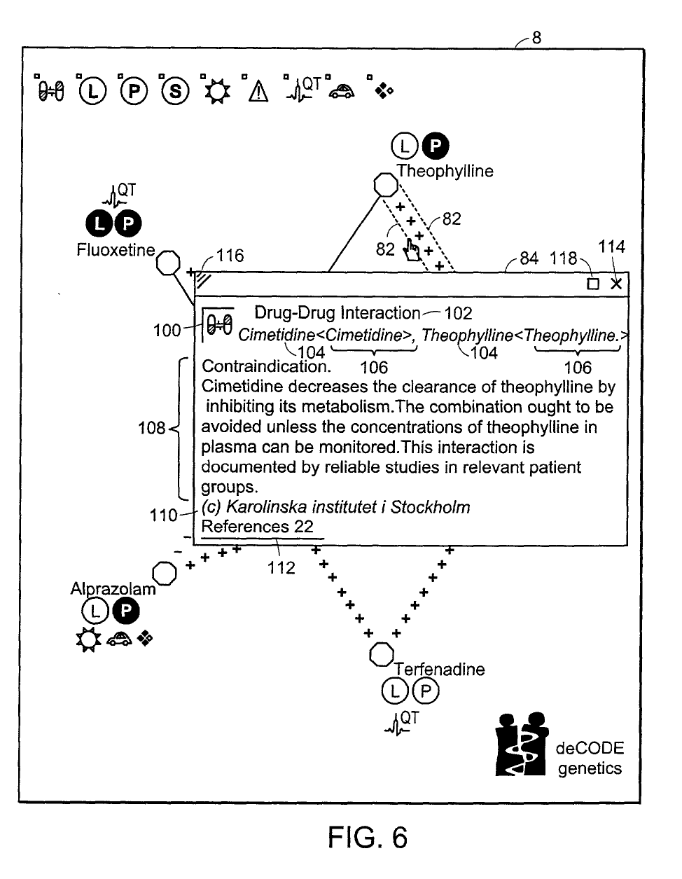

As FIG. 6 illustrates, for example, the user can access further explanations of the warnings by moving the pointer over the working items (interactive spots). When the pointer is moved over an interactive spot, gray lines 82 are drawn around the subject spot and descriptive text appears in a textbox 84. Similarly, if the mouse pointer is moved over a drug label or drug node, a textbox appears containing all warnings and interactions that apply to the selected drug. When the pointer moves off an interactive spot, the textbox normally disappears.

The textbox 84 shown in FIG. 6 displays detailed information on interactions, along with references. An icon 100 descriptive of the warning/text type (here: drug interaction) is displayed in the upper left corner and a text heading 102 is displayed in the center. The icon 100 and text 102 may be color-coded according to the type and severity of the warning, if appropriate. The name or names 104 of the drugs to which the warning applies are displayed under the heading 102. Next to these names 104 are the names 106 of the active ingredients, displayed in italics and enclosed within brackets (<>).

The main text 108 of the textbox 84 is displayed under the drug names 104. The main text 108 ends with a line 110 in italics that indicates the origin or source of the text, if applicable. Links 112 to further references may also be provided.

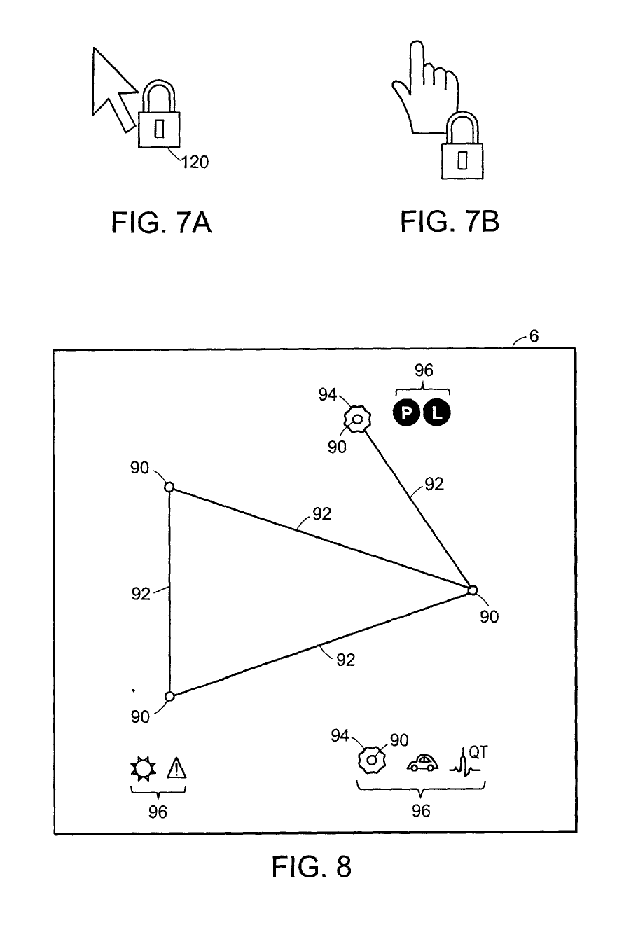

The textbox 84 can be locked on the screen by, for example, pressing the left mouse button while the pointer is over an interactive spot. When the textbox 84 is locked, the pointer changes to a locked pointer (or similar symbolic cursor) 120 as illustrated in FIG. 7A. With the textbox 84 locked, the pointer is allowed to move around the screen without the textbox 84 disappearing. With a locked textbox 84, the text in the box can be scrolled up and down if necessary, and links 112 within the textbox can be selected. The textbox 84 may be unlocked in one of three ways: by moving the pointer off the textbox 84, by pressing the left mouse button while pointing at the close control 114 or by pressing the ESC button on the keyboard.

The size of the textbox 84 can be changed by moving the pointer over the size button 116, pressing and holding the left mouse button and moving the mouse in the direction of the wanted size change. The size of the textbox 84 can be changed to fill screen by pressing the left mouse button while having the pointer over the full screen button 118. In some cases, it may not be possible to change the size of textbox 84.

When the pointer is moved over a link 112, the pointer changes to the symbolic cursor shown in FIG. 7B. A link 112 can be selected by pressing a mouse button while the cursor hovers over the link 112. When a link has been selected, new text appears in the textbox 84. It is possible to go back to the original text by selecting a back link (not shown).

FIG. 8 illustrates a small display mode window 6, corresponding to the small display window 6 of FIG. 1.

In small display mode, all drugs that have any warning attached to them are represented as a node 90 with a small white circle with black outlines. Drug-drug interactions are represented by lines 92 connecting the drugs that are involved in the interaction. The colors of the lines indicate the type and severity of the interactions in the same way as with large display mode. However, in one embodiment, the effects of the interactions and the names of the drugs are not shown in small display mode.

A drug allergy is indicated with a red blinking dot and beacon 94. Possible cross-allergies are indicated with an orange blinking dot and beacon. Small symbolic icons 96 in the corners of the small display mode indicate the most severe warning of each type that applies collectively to the drugs shown.

In one embodiment, the user may cause the system to go from small display mode to large display mode by double-clicking anywhere within the small display window 6. Other embodiments may permit different ways to move from mode to mode.

The small display mode offers the healthcare professional a fast and easy way of being alerted to drug-drug interactions and any serious warnings with respect to drugs the patient is taking. If the healthcare professional wants more information, he or she can switch to the large display mode 8 (FIG. 4).

DAX has been designed primarily for two main uses, which apply to both small and large display modes.

The first use is where the patient's current drug list is being reviewed. Here, DAX displays all drug-drug interactions and all warnings that apply to any drug that the patient is taking. This provides an excellent overview of the patient's current drug status that can be quickly assessed by the healthcare professional.

When the user is reviewing the patient's current drug list, DAX first runs in small window mode (FIG. 8), providing a quick overview of interactions and warnings that apply to the drugs.

The user can then click on the small DAX window 6 or use another selection method to open DAX in large window/full screen mode (FIG. 4) for a more detailed view.

In this first use, information regarding all drugs that the patient is currently taking and interactions between all of them are displayed.

The second major use is where a new drug is being prescribed. In this case, DAX shows only drug-drug interactions between the new drug and the drug that the patient is currently taking and shows only warnings that apply to the new drug. The healthcare professional can again quickly and reliably assess how and if the new drug fits into the patient's current drug list and allows the healthcare professional to select the safest drug for the patient in an expedient fashion.

DAX can also be used in other scenarios, such as a standalone program for users who wish to try out drug combinations or use the system as a drug reference.

In addition, DAX can be used in a web-based form for public access.

DAX's graphical representation of data gives healthcare professionals a new and easy way of analyzing how drug-drug interactions interact in patients taking multiple drugs. It is often necessary, for safety reasons, to view drug-drug interactions from a broad perspective rather than reviewing them one by one.

For example, some drugs have two main routes of excretion. If a drug-drug interaction blocks one of these routes, no problems may arise because either route has more than enough capacity on its own. However, if the remaining open route is then blocked by another drug-drug interaction, serious problems could arise. Thus, two or more clinically insignificant drug-drug interactions when combined can cause serious clinical problems.

DAX makes it easy for healthcare professionals to assess the total effect of many simultaneously acting drug-drug interactions. There are three main effects that should be considered when effects of multiple drug-drug interactions are assessed: extended effects, additive effects and chain reactions.

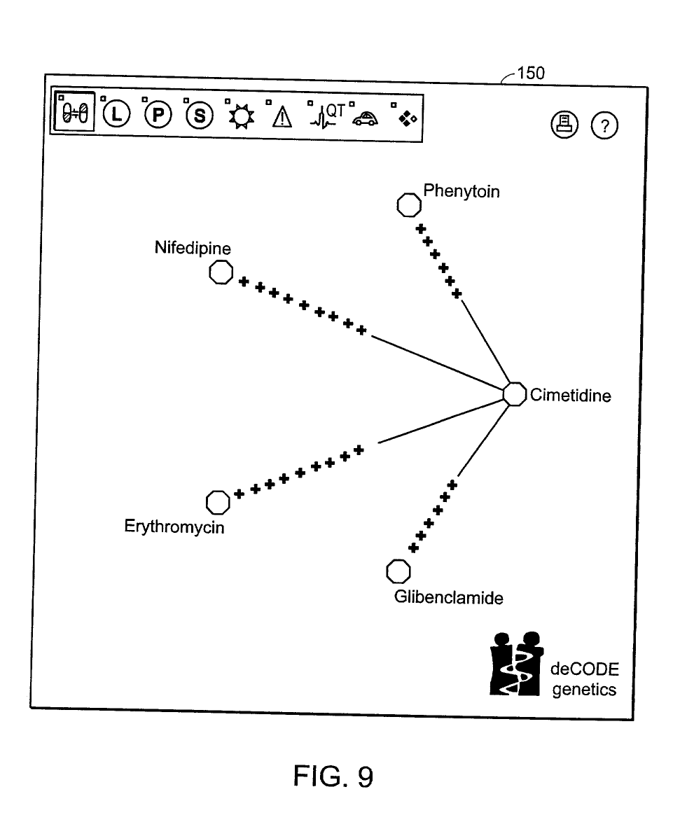

FIG. 9 is an illustration of a screen display 150 indicating extended effects.

DAX makes it easy to spot drugs that have extended effects. Here, the display 150 shows that cimetidine increases the effects of four other drugs. Such is indicated by the plus signs at the distal ends of the respective connecting lines from cimetidine to the four drugs. In this case, it would be advisable to select some drug other than cimetidine in order to prevent undesirable effects.

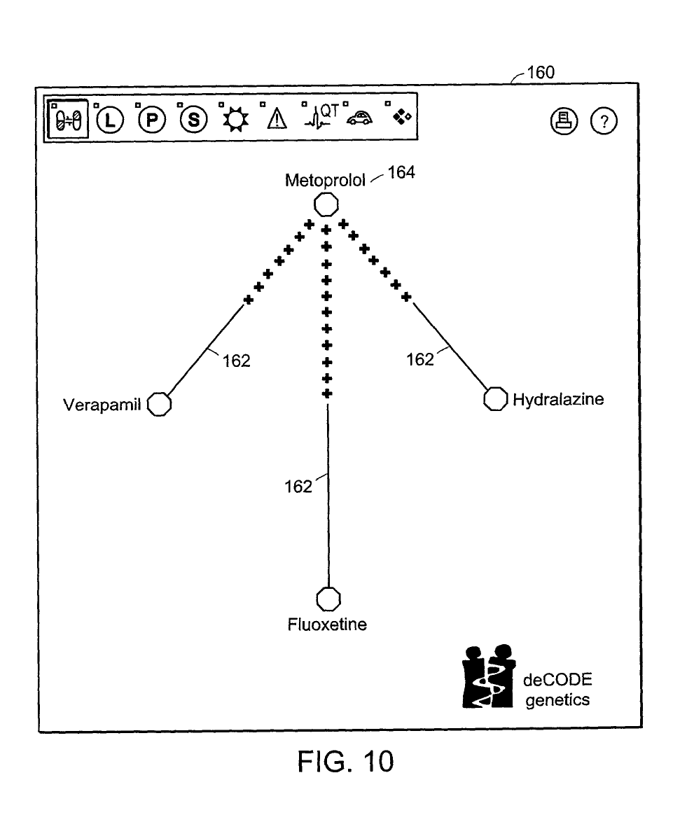

FIG. 10 is an illustration of a screen display 160 indicating additive effects. When two or more drug-drug interactions affect the same drug, they can have additive effects. The screen display 160 illustrates how verapamil, hydralazine and fluoxetine all increase the effects of metoprolol. That is, the plus signs are all at the metoprolol end of each connecting line. Each of these interactions 162 may have insignificant clinical effects individually on their own, yet when more than one of them affect the same drug 164 and all of them either increase or decrease the effect of the drug, a clinically significant overall effect is likely to arise.

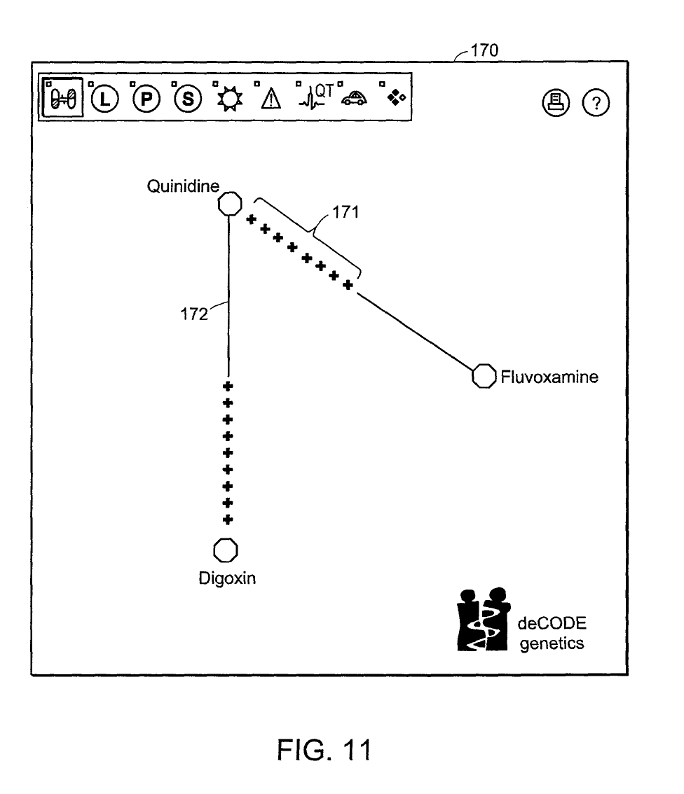

FIG. 11 is an illustration of a screen display 170 indicating chain reactions. Chain reacting effects can occur between drug-drug interactions. Chain reactions can increase or decrease the effects of drug-drug interactions and in that manner cause toxic or cancelled effects.

FIG. 11 illustrates a simple magnifying chain reaction where fluvoxamine increases the effects of quinidine (illustrated by plus signs series 171), which in turn increases the effects of digoxin (indicated by the plus signs at the digoxin end of interaction line 172). In this example, there is a danger of greater increase in digoxin effects than one would expect from the interaction 172 between quinidine and digoxin alone.

While drug-drug interactions are analyzed in DAX, it must be kept in mind that drug-drug interactions increase or decrease the effects of drugs by different means. Some interactions affect the absorption of drugs, while others affect the excretion, protein binding or some other properties. It cannot be taken as granted that two interactions that both increase the effects of a drug increase the effects more when they both interact simultaneously. Analysis of multiple drug-drug interactions is typically an approximation.

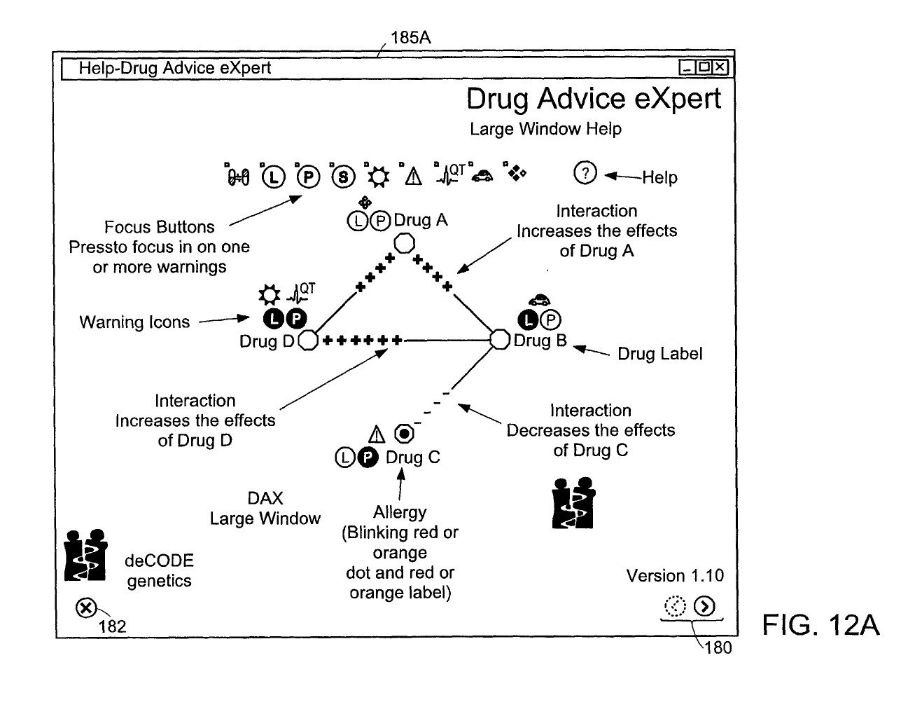

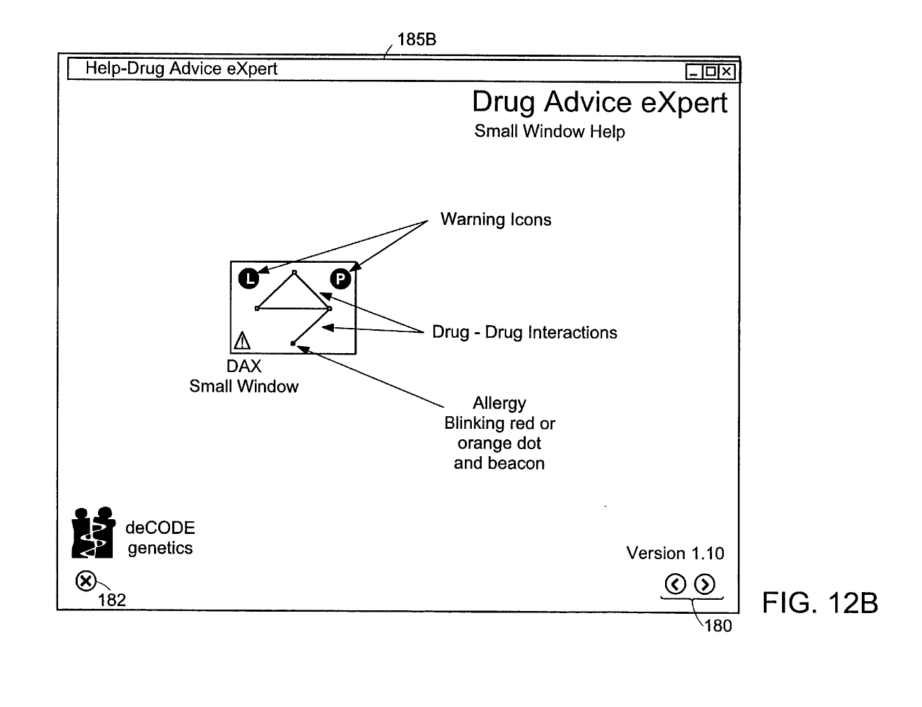

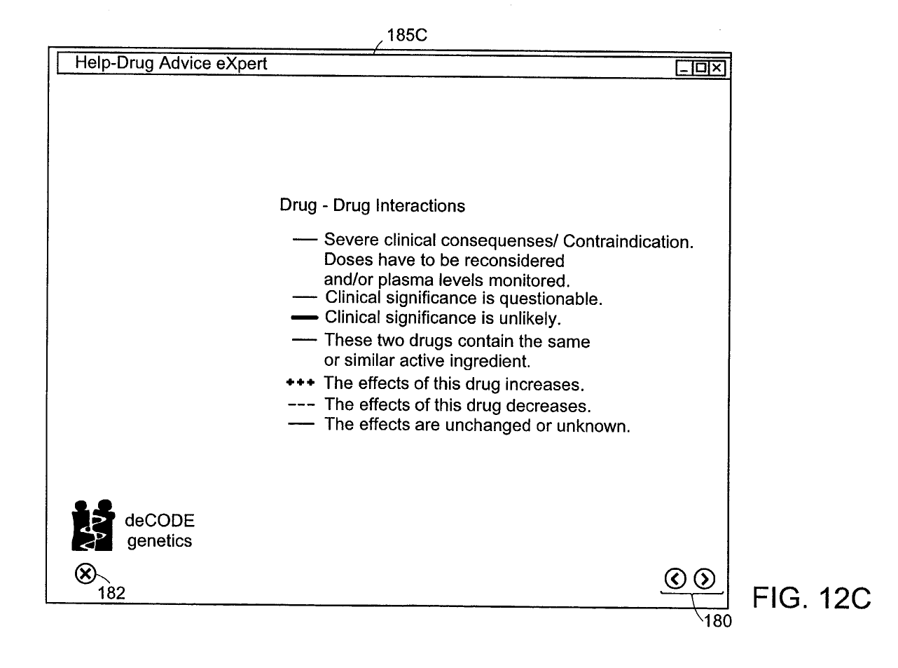

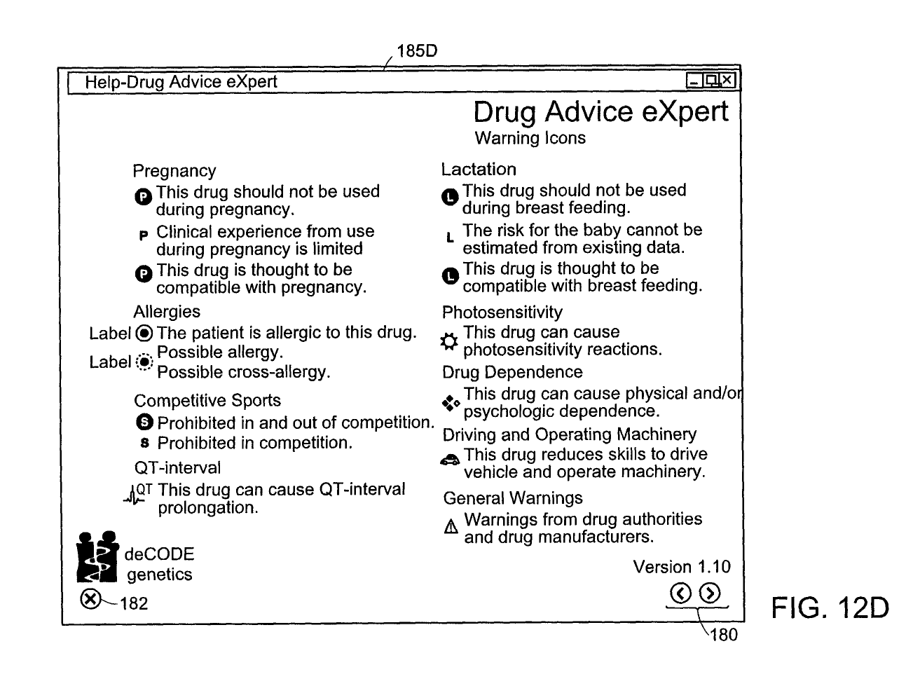

As FIGS. 12A-12D illustrate, DAX has an integrated help function that allows users to access quick and easy explanations of DAX's main functions. The help function is readily available by selecting the help button 89 in the large display (FIG. 4). When the help function has been selected, the user can browse back and forth through the help screens 185A-185D by selecting the navigation buttons 180 or alternatively by using keyboard arrow keys. The help function can be exited by selecting the exit button 182 or by pressing the ESC key on the keyboard.

The various help screens 185A-185D provide explanations of the various symbols, icons, lines (drug interactions), color coding, plus and minus signs and labels.

Those of ordinary skill in the art should recognize that methods involved in a drug interaction device may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as a bus or a communications link, either optical, wired, or wireless, carrying program code segments as digital or analog data signals.

While the invention has been particularly shown and described with references to particular embodiments, it will be understood by those of ordinary skill in the art that various changes in form and details may be made without departing from the scope of the invention encompassed by the appended claims. For example, the methods of the invention can be applied to various environments, and are not limited to the described environment.

In another example, the foregoing description of the preferred embodiment refers to use of a mouse or keyboard for cursor control and user input. Other input devices are suitable such as, but not limited to, electronic stylus, laser pointers, touchsensitive screens and the like.

What is claimed is:

1. A method for providing expert drug advice, comprising:
representing drugs as nodes in a graph in a computer display window; and
graphically representing a property associated with a first represented drug.

2. The method of claim 1, wherein the graphically represented property is interaction between the first drug and a second represented drug.

3. The method of claim 2, wherein the interaction is indicated by a line connecting nodes representing the first and second drugs.

4. The method of claim 3, wherein the line further indicates whether at least one of the first drug and second drug increases/decreases effectiveness of the other drug.

6. The method of claim 4, further comprising:
using plus signs (“+”) to indicate increased effectiveness; and
using minus signs (“−”) to indicate decreased effectiveness.

7. The method of claim 3, wherein the line further indicates a strength of the interaction.

8. The method of claim 7, further comprising:
adjusting thickness of the line based on the strength of the interaction.

9. The method of claim 7, further comprising:
color-coding the line based on the strength of the interaction.

11. The method of claim 3, wherein any combination of extended effects, additive effects and chain reactions is illustrated.

12. The method of claim 2, wherein the represented drugs are from a drug list.

13. The method of claim 12, further comprising:
indicating interactions between drugs on the drug list.

14. The method of claim 12, further comprising:
representing a proposed drug as a node; and
indicating interactions between the proposed drug and drugs on the drug list.

15. The method of claim 12, further comprising:
representing a proposed drug as a node; and
indicating interactions between the proposed drug and other displayed drugs.

16. The method of claim 2, wherein drug interaction representation is responsive to patient data.

17. The method of claim 16, further comprising:
maintaining, in a database, at least one of historical and current patient data.

18. The method of claim 16, wherein patient data comprises drug dosages.

19. The method of claim 1, wherein the property is a warning associated with the drug.

20. The method of claim 19, wherein the graphically represented warning of the first drug is related to at least one of: allergic reactions, pregnancy, lactation, QT-interval prolongation, impaired ability to operate a motor vehicle/machinery, drug dependence, competitive sports, photosensitivity, general warnings, side effects, overdose, affect on at least one organ, and food/drug interactions.

21. The method of claim 20, wherein the graphically represented warning related to impaired ability to operate a motor vehicle/machinery includes warnings based on effects due to any of blurred vision, muscle relaxation, drowsiness and dizziness.

22. The method of claim 19, further comprising:
indicating possible allergic reactions of the first drug by blinking the associated node.

23. The method of claim 19, further comprising:
indicating severity of the warning using color coding.

24. The method of claim 19, further comprising:
providing soft switches with which a user can selectively enable/disable different warning types.

25. The method of claim 1, further comprising:
providing a small window mode in which limited information is provided in a small display window.

26. The method of claim 1, further comprising:
providing a large window mode in which detailed information is provided in a large display window.

27. The method of claim 26, further comprising:
providing a small window mode in which limited information is provided in a small display window.

28. The method of claim 27, further comprising:
passing from the small window mode to the large window mode in response to user action in the small display window.

29. The method of claim 1, further comprising:
integrating software that performs the steps of claim 1 with an independently-developed application; and
integrating the window with graphical output of the application.

30. The method of claim 29, wherein the independently-developed application is a drug prescription software application.

31. The method of claim 29, further comprising:
providing an application program interface (API) for interfacing with the independently-developed application.

32. The method of claim 31, the independently-developed application further providing information about a patient through the API.

33. The method of claim 1, further comprising:
including a graphical help function.

34. The method of claim 1, further comprising:
maintaining at least one database for storing drug property information; and
retrieving said information from said at least one database.

35. The method of claim 34, wherein said stored information comprises at least one of pharmacokinetic, pharmacodynamic and drug-specific information.

36. The method of claim 34, further comprising:
indexing the database according to medical standard classifications.

37. The method of claim 1, further comprising:
displaying additional information when a cursor is made to hover over an interactive spot.

38. The method of claim 37, wherein the additional information includes a link to other information.

39. The method of claim 37 wherein the interactive spot is a drug node and the additional information includes details and references regarding the drug.

40. The method of claim 1, further comprising:
color-coding a drug node with a first color to indicate drug allergies, and with a second color to indicate possible cross-allergies.

41. The method of claim 1, further comprising:
color coding a node to indicate degree of certainty of an allergic reaction.

42. The method of claim 1, wherein the drug property is represented based on patient characteristics.

43. The method of claim 42, wherein patient characteristics include any of age, gender, current drug list, diagnosis, symptoms, cost and allergies.

44. Computer apparatus comprising:
a database containing drug information;
a digital processor coupled to the database; and
a driver executing on the digital processor which
accesses the database,
represents drugs as nodes in a graph in a display window, and
graphically represents a property associated with a first represented drug based on the drug information.

45. The computer apparatus of claim 44, wherein the graphically represented property is interaction between the first drug and a second represented drug.

46. The computer apparatus of claim 45, wherein the interaction is indicated by a line connecting nodes representing the first and second drugs.

47. The computer apparatus of claim 46, wherein the line further indicates whether at least one of the first drug and second drug increases/decreases effectiveness of the other drug.

49. The computer apparatus of claim 47, wherein plus signs (“+”) indicate increased effectiveness, and minus signs (“−”) indicate decreased effectiveness.

50. The computer apparatus of claim 46, wherein the line further indicates strength of the interaction.

51. The computer apparatus of claim 50, wherein thickness of the line indicates strength of the interaction.

52. The computer apparatus of claim 50, wherein the line is color-coded based on the strength of the interaction.

54. The computer apparatus of claim 46, wherein any combination of extended effects, additive effects and chain reactions is illustrated.

55. The computer apparatus of claim 45, wherein the represented drugs are from a drug list.

56. The computer apparatus of claim 55, wherein interactions between drugs on the drug list are indicated.

57. The computer apparatus of claim 55, wherein a proposed drug is represented as a node, and interactions between the proposed drug and drugs on the drug list are indicated.

58. The computer apparatus of claim 55, wherein a proposed drug is represented as a node, and interactions between the proposed drug and other displayed drugs are indicated.

59. The computer apparatus of claim 45, wherein drug interaction representation is responsive to patient data.

60. The computer apparatus of claim 59, further comprising:
a database for storing at least one of historical and current patient data.

61. The computer apparatus of claim 59, wherein patient data comprises drug dosages.

62. The computer apparatus of claim 45, wherein the property is a warning associated with the drug.

63. The computer apparatus of claim 62, wherein the graphically represented warning of the first drug is related to at least one of: allergic reactions, pregnancy, lactation, QT-interval prolongation, impaired ability to operate a motor vehicle/machinery, drug dependence, competitive sports, photosensitivity, general warnings, side effects, overdose, affect on at least one organ, and food/drug interactions.

64. The computer apparatus of claim 63, wherein the graphcially represented warning related to impaired ability to operate a motor vehicle/machinery includes warnings based on effects due to any of blurred vision, muscle relaxation, drowsiness and dizziness.

65. The computer apparatus of claim 62, wherein possible allergic reactions of the first drug are indicated by blinking the associated node.

66. The computer apparatus of claim 62, wherein the warning is color-coded to indicate severity.

67. The computer apparatus of claim 62, wherein the driver further displays soft switches with which a user can selectively enable/disable different warning types.

68. The computer apparatus of claim 44, wherein the driver displays limited information in a small display window.

69. The computer apparatus of claim 44, wherein the driver displays detailed information in a large display window.

70. The computer apparatus of claim 69, wherein the driver displays, at any time, one of the large display window, and a small display window in which limited information is provided.

71. The computer apparatus of claim 70, wherein the large display window is displayed in response to a user action in the small display window.

72. The computer apparatus of claim 44, wherein the driver is integrated with an independently-developed application, and the driver's display is integrated with graphical output of the application.

73. The computer apparatus of claim 72, wherein the independently-developed application is a drug prescription software application.

74. The computer apparatus of claim 72, further comprising:
an application program interface (API) for interfacing with the independently-developed application.

75. The computer apparatus of claim 74, wherein the independently-developed application further provides information about a patient through the API.

76. The computer apparatus of claim 44, further comprising:
a graphical help function.

77. The computer apparatus of claim 44, wherein drug information in the database comprises at least one of pharmacokinetic, pharmacodynamic and drug-specific information.

78. The computer apparatus of claim 44, wherein the database is indexed according to medical standard classifications.

79. The computer apparatus of claim 44, wherein the driver displays additional information when a cursor is made to hover over an interactive spot.

80. The computer apparatus of claim 79, wherein the additional information includes a link to other information.

81. The computer apparatus of claim 79 wherein the interactive spot is a drug node and the additional information includes details and references regarding the drug.

82. The computer apparatus of claim 44, wherein the driver colors a drug node with a first color to indicate drug allergies, and with a second color to indicate possible cross-allergies.

83. The computer apparatus of claim 44, wherein the driver colors a node to indicate degree of certainty of an allergic reaction.

84. The computer apparatus of claim 44, wherein the drug property is represented based on patient characteristics.

85. The computer apparatus of claim 84, wherein patient characteristics include any of age, gender, current drug list, diagnosis, symptoms, cost and allergies.

86. Computer apparatus comprising:
means for representing drugs as nodes in a graph in a display window; and
means for graphically representing a property associated with a first represented drug.

87. A drug advice expert computer program product, the computer program product comprising a computer usable medium having computer readable code thereon, including program code which:
represents drugs as nodes in a graph in a display window; and
graphically represents a property associated with a first represented drug.
